(19) United States
(12) Patent Application Publication
(10) Pub. No.: US 2023/0213231 A1
(43) Pub. Date: Jul. 6, 2023

(54) Wireless HVAC Control Assembly

(71) Applicant: Jairus Watkins, Lithonia, GA (US)

(72) Inventor: Jairus Watkins, Lithonia, GA (US)

(21) Appl. No.: 17/565,564

(22) Filed: Dec. 30, 2021

(51) Int. Cl. F24F 11/50; G08C 17/02

(52) U.S. Cl. CPC F24F 11/50; G08C 17/02

(57) ABSTRACT

A wireless HVAC control assembly for wirelessly actuating a heat pump includes a thermostat that is positioned within a building. An air handling unit is positioned within the building and the air handling unit is in electrical communication with the thermostat. A transmitter is integrated into the air handling unit and the transmitter broadcasts an actuate signal when the thermostat is actuated into the cooling condition. A heat pump is positioned outside of the building and a receiver is integrated into the heat pump. The receiver is in wireless communication with the transmitter and the heat pump is actuated into a cooling condition when the receiver receives the actuate signal from the transmitter.

### CROSS-REFERENCE TO RELATED APPLICATIONS

Not Applicable

### STATEMENT REGARDING FEDERALLY SPONSORED RESEARCH OR DEVELOPMENT

Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Applicable

### BACKGROUND OF THE INVENTION

### (1) Field of the Invention

The disclosure relates to wireless control devices and more particularly pertains to a new wireless control device for wirelessly actuating a heat pump. The device includes a transmitter that is integrated into an air handling unit of a heating, ventilation and air conditioning system. The device includes a receiver that is integrated into a heat pump of the heating, ventilation and air conditioning system, and the receiver is in wireless communication with the transmitter. The transmitter broadcasts an actuate signal to the receiver when a thermostat is actuated into a cooling condition. In this way the heat pump is wirelessly controlled by the thermostat.

### (2) Description of Related Art Including Information Disclosed Under 37 CFR 1.97 and 1.98

The prior art relates to wireless control devices including an HVAC system that includes a programmable thermostat and a HVAC unit. The prior art discloses an HVAC system that includes leakage detecting incorporated into ductwork. The prior art discloses a wireless HVAC control device that includes a wireless thermostat, a plurality of vent actuators that are in wireless communication with the wireless thermostat and a control unit. The prior art discloses a remote HVAC control device that includes a wireless device that is in remote communication with one or more components of an HVAC system for remotely controlling the HVAC system.

### BRIEF SUMMARY OF THE INVENTION

An embodiment of the disclosure meets the needs presented above by generally comprising a thermostat that is positioned within a building. An air handling unit is positioned within the building and the air handling unit is in electrical communication with the thermostat. A transmitter is integrated into the air handling unit and the transmitter broadcasts an actuate signal when the thermostat is actuated into the cooling condition. A heat pump is positioned outside of the building and a receiver is integrated into the heat pump. The receiver is in wireless communication with the transmitter and the heat pump is actuated into a cooling condition when the receiver receives the actuate signal from the transmitter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a schematic view of a wireless HVAC control assembly according to an embodiment of the disclosure.

FIG. 2 is a perspective view of an embodiment of the disclosure.

### DETAILED DESCRIPTION OF THE INVENTION

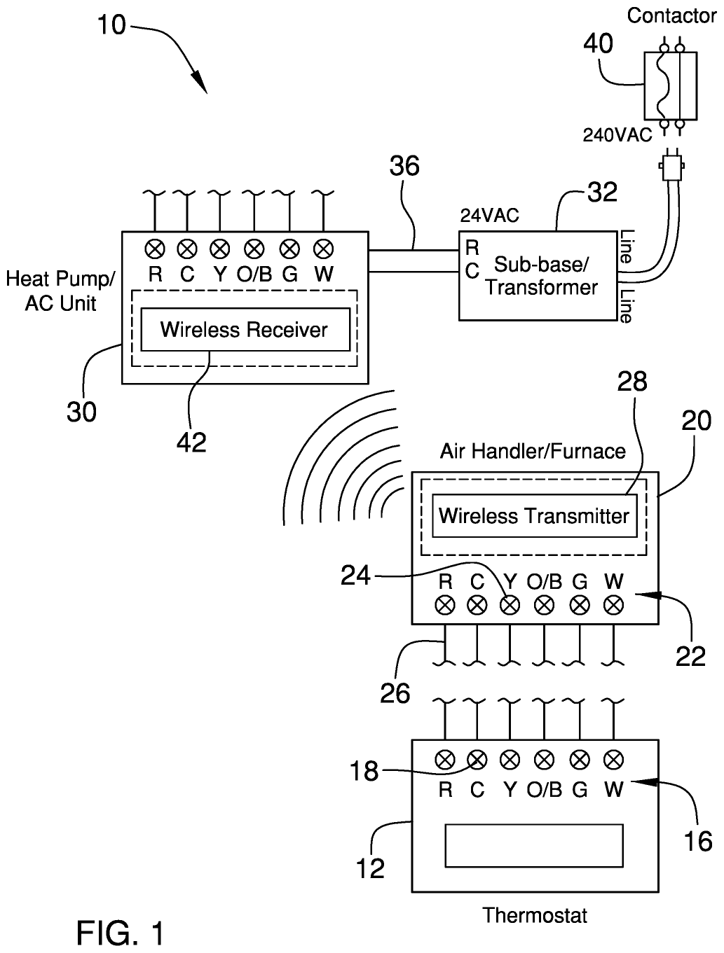

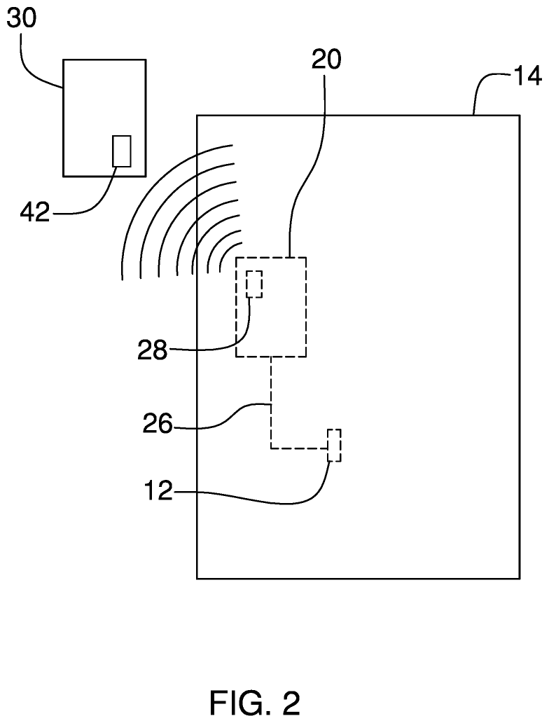

With reference now to the drawings, and in particular to FIGS. 1 through 2 thereof, a new wireless control device embodying the principles and concepts of an embodiment of the disclosure and generally designated by the reference numeral 10 will be described.

As best illustrated in FIGS. 1 through 2, the wireless HVAC control assembly 10 generally comprises a thermostat 12 that is positioned within a building 14. The building 14 may be a house or other type of building that would commonly be occupied by one or more individuals. The thermostat 12 has a plurality of output contacts 16 and the plurality of output contacts 16 includes a cooling contact 18. Additionally, the thermostat 12 is actuatable into a cooling condition and the thermostat 12 may comprise a thermostat of any conventional design that is commonly employed in a heating, ventilation and air conditioning system. Furthermore, the cooling contact 18 may be an electrical contact commonly referred to as a “Y” contact on the thermostat 12.

An air handling unit 20 provided, the air handling unit 20 is positioned within the building 14 and the air handling unit 20 is in electrical communication with the thermostat 12. The air handling unit 20 has a plurality of input contacts 22 and the plurality of input contacts 22 includes a cooling contact 24. The air handling unit 20 may comprise an electric furnace, a gas fired furnace or any other type of air blower that is commonly employed in a heating, ventilation and air conditioning system. Additionally, the cooling contact 24 associated with the input contacts 22 may be an electrical contact commonly referred to as a “Y” contact on the air handling unit 20.

A conductor 26 is provided and the conductor 26 is electrically coupled between the output contacts 16 on the thermostat 12 and the plurality of input contacts 22 on the air handling unit 20. In this way the thermostat 12 is electrically coupled to the air handling unit 20 thereby facilitating direct electrical communication between the cooling contact 18 associated with the output contacts 16 and the cooling contact 24 associated with the input contacts 22. The cooling contact 18 associated with the input contacts 22 receives a cooling signal from the cooling contact 24 associated with the output contacts 16 when the thermostat 12 is actuated into the cooling condition.

A transmitter 28 is integrated into the air handling unit 20 and the transmitter 28 is in electrical communication with the air handling unit 20. The transmitter 28 broadcasts an actuate signal when the thermostat 12 is actuated into the cooling condition. Furthermore, the transmitter 28 is electrically coupled to the cooling contact 24 associated with the plurality of input contacts 22 on the air handling unit 20. The transmitter 28 broadcasts the actuate signal when the cooling contact 24 associated with the input contacts 22 receives the cooling signal from the cooling contact 18 associated with the output contacts 16 on the thermostat 12. The transmitter 28 may comprise a radio frequency transmitter or the like and the transmitter 28 may employ Bluetooth communication protocols. Additionally, the transmitter 28 may have a signal strength sufficient to pass through interior and exterior walls of the building 14 such that transmitter 28 has an operational range of at least 50.0 feet away from the building 14.

A heat pump 30 is provided and the heat pump 30 is positioned outside of the building 14. The heat pump 30 may be a heat pump of any conventional design that is commonly employed in heating, ventilation and air conditioning systems. A transformer 32 is coupled to the heat pump 30 and the transformer 32 has an input 34 and an output 36. The input 34 is electrically coupled to a power source 40 comprising a 240.0 volt electrical circuit of the building 14. The transformer 32 decreases voltage from the power source 40 to a signal voltage employed by the power input 34 of the heat pump 30. The transformer 32 may be a step-down transformer of any conventional design that is capable of reducing 240.0 volts of alternating current down to 24.0 volts of alternating current. The input 34 of the transformer 32 may comprise a male electrical plug that is matable to a female electrical socket which receives 240.0 volts of alternating current.

A receiver 42 is provided and the receiver 42 is integrated into the heat pump 30. The receiver 42 is in electrical communication with the heat pump 30 and the receiver 42 is in wireless communication with the transmitter 28. Moreover, the heat pump 30 is actuated into a cooling condition when the receiver 42 receives the actuate signal from the transmitter 28. Additionally, the receiver 42 is electrically coupled to the output 36 of the transformer 32 such that the transformer 32 facilitates operational voltage for the receiver 42. The receiver 42 may comprise a radio frequency receiver or the like and the receiver 42 may employ Bluetooth communication protocols.

In use, the transmitter 28 and the receiver 42 take the place of a low voltage conductor 26 that is commonly installed between the air handler and a heat pump 30 of a heating, ventilation and air conditioning system. Thus, the heat pump 30 can be wirelessly actuated into the cooling condition when the thermostat 12 is actuated into the cooling condition. In this way the possibility of developing a short circuit or other type of electrical fault, in the low voltage conductor 26 is eliminated. Thus, the process of troubleshooting a malfunction in the heating, ventilation and air conditioning system is simplified for a technician with respect to the process of identifying and locating a short circuit, or other electrical fault, in conventional low voltage conductors. Furthermore, the transformer 32 facilitates a low voltage signal to be available to the heat pump 30 and the transmitter 28 in a manner that does not rely on the conventional process of installing the low voltage conductor between the thermostat 12 and the heat pump 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wireless HVAC control assembly for wirelessly transmitting a low voltage signal between a thermostat and a heat pump, said assembly comprising:
a thermostat being positioned within a building;
an air handling unit being positioned within the building, said air handling unit being in electrical communication with said thermostat;
a transmitter being integrated into said air handling unit, said transmitter being in electrical communication with said air handling unit, said transmitter broadcasting an actuate signal when said thermostat is actuated into said cooling condition;
a heat pump being positioned outside of the building; and
a receiver being integrated into said heat pump, said receiver being in electrical communication with said heat pump, said receiver being in wireless communication with said transmitter, said heat pump being actuated into a cooling condition when said receiver receives said actuate signal from said transmitter.

2. The assembly according to claim 1, wherein:
said thermostat has a plurality of output contacts, said plurality of output contacts including a cooling contact, said thermostat being actuatable into a cooling condition;
said air handling unit has a plurality of input contacts, said plurality of input contacts including a cooling contact;
said assembly includes a conductor being electrically coupled between said output contacts on said thermostat and said plurality of input contacts on said air handling unit such that said thermostat is electrically coupled to said air handling unit thereby facilitating direct electrical communication between said cooling contact associated with said output contacts and said cooling contact associated with said input contacts, said cooling contact associated with said input contacts receiving a cooling signal from said cooling contact associated with said output contacts when said thermostat is actuated into said cooling condition; and
said transmitter is electrically coupled to said cooling contact associated with said plurality of input contacts on said air handling unit.

3. The assembly according to claim 2, wherein said transmitter broadcasts said actuate signal when said cooling contact associated with said input contacts receives said cooling signal from said cooling contact associated with said output contacts on said thermostat.

4. The assembly according to claim 1, further comprising a transformer being coupled to said heat pump, said transformer having an input and an output, said input being electrically coupled to a power source comprising a 240.0 volt electrical circuit of the building, said transformer decreasing a power voltage from the power source to a signal voltage employed by said power input of said heat pump.

5. The assembly according to claim 4, wherein said receiver is electrically coupled to said output of said transformer.

6. A wireless HVAC control assembly for wirelessly transmitting a low voltage signal between a thermostat and a heat pump, said assembly comprising:
a thermostat being positioned within a building, said thermostat having a plurality of output contacts, said plurality of output contacts including a cooling contact, said thermostat being actuatable into a cooling condition;
an air handling unit being positioned within the building, said air handling unit being in electrical communication with said thermostat, said air handling unit having a plurality of input contacts, said plurality of input contacts including a cooling contact;
a conductor being electrically coupled between said output contacts on said thermostat and said plurality of input contacts on said air handling unit such that said thermostat is electrically coupled to said air handling unit thereby facilitating direct electrical communication between said cooling contact associated with said output contacts and said cooling contact associated with said input contacts, said cooling contact associated with said input contacts receiving a cooling signal from said cooling contact associated with said output contacts when said thermostat is actuated into said cooling condition;
a transmitter being integrated into said air handling unit, said transmitter being in electrical communication with said air handling unit, said transmitter broadcasting an actuate signal when said thermostat is actuated into said cooling condition, said transmitter being electrically coupled to said cooling contact associated with said plurality of input contacts on said air handling unit, said transmitter broadcasting said actuate signal when said cooling contact associated with said input contacts receives said cooling signal from said cooling contact associated with said output contacts on said thermostat;
a heat pump being positioned outside of the building;
a transformer being coupled to said heat pump, said transformer having an input and an output, said input being electrically coupled to a power source comprising a 240.0 volt electrical circuit of the building, said transformer decreasing voltage from the power source to a signal voltage employed by said power input of said heat pump; and
a receiver being integrated into said heat pump, said receiver being in electrical communication with said heat pump, said receiver being in wireless communication with said transmitter, said heat pump being actuated into a cooling condition when said receiver receives said actuate signal from said transmitter, said receiver being electrically coupled to said output of said transformer.

7. A method of wirelessly controlling a heat pump in a heating, ventilation and air conditioning system, the steps of the method comprising:
providing a thermostat having a cooling contact;
providing an air handler having a cooling contact;
providing a conductor;
providing a heat pump;
providing a transmitter being integrated into said air handler;
providing a receiver being integrated into said heat pump;
providing a transformer being electrically coupled to said heat pump, said transformer having an input and an output;
coupling said input of said transformer to a power source;
coupling said conductor between said cooling contact of said thermostat and said cooling contact of said air handler;
coupling said receiver to said output of said transformer;
synching said receiver to said transmitter; and
actuating said thermostat into a cooling condition such that said transmitter broadcasts an actuate signal to said receiver such that said heat pump is actuated into a cooling condition when said thermostat is actuated into said cooling condition.
